(19) United States
(12) Patent Application Publication
(10) Pub. No.: US 2009/0307305 A1
(43) Pub. Date: Dec. 10, 2009

(54) NETWORK ALLOCATION

(75) Inventor: Kenneth Chu, San Diego, CA (US)

Correspondence Address: Berkeley Law & Technology Group LLP, 17933 NW Evergreen Parkway, Suite 250, Beaverton, OR, 97006, US

(73) Assignee: Entropic Communications, Inc., San Diego, CA (US)

(21) Appl. No.: 12/136,646

(22) Filed: Jun. 10, 2008

(51) Int. Cl. G06F 15/16; G06F 15/173

(52) U.S. Cl. 709/203; 709/223

(57) ABSTRACT

A method and apparatus of supporting more than the maximum number of clients allowed in a network. Such limitations exist because of resource limitations, such as memory and other hardware. In one embodiment of the disclosed method and apparatus, a network controller temporarily drops a client out of a network to allow another client, which is currently not in the network and wishes to be active, to join the network. Information about the link between the dropped client and the network controller is stored to allow the dropped client to easily rejoin the network.

### BACKGROUND

1. Field

The subject matter disclosed herein relates to allocating client membership to a network and more specifically to increasing the number of clients that can join a network.

2. Background

Recently, the popularity of multimedia data services within a household or business has been increasing. In response, distributing such multimedia data services, such as digital video, through coaxial cable has been enabled by devices developed, for example, according to standards set by the Multimedia over Coax Alliance (MoCA). In accordance with these standards, signals, such as signals for carrying multimedia data services, enter a home or building over a coaxial cable network at a point-of-entry (POE). From a POE, and within a home or building, such signals are distributed to various terminals, nodes, customer premise equipment (CPE) and/or clients that are a part of a communication network such as a broadband cable network (BCN), for example. Such terminals, nodes, CPE'S, and/or clients, hereinafter referred to as clients, are connected to various entities, such as cable converter boxes, televisions, video monitors, cable modems, cable phones, and video game consoles, just to name a few examples of entities that may utilize multimedia data services.

A link to clients utilizes a signaling technique such as a bitloading modulation scheme. Different links may utilize different bitloading modulation schemes because the links may have different physical and/or electrical properties. Physically, links to different clients from a transmission source vary in length and, electrically, such links vary because of the paths through and reflections from various elements, such as cables, switches, terminals, connections, and other electrical components in the network. Transmission characteristics of a link are described in terms of a signal-to-noise ratio (SNR), a bit-error rate (BER), and/or power level of a signal received at a client such as a remote device, for example.

Bitloading refers to a process of optimizing the modulation techniques to increase throughput. In one particular example, a BCN uses bitloaded orthogonal frequency division multiplexing (OFDM). Accordingly, the BCN transmits multiple carrier signals with different QAM (Quadrature Amplitude Modulation) constellations on each carrier signal, for example.

A network coordinator, or network controller (NC), is positioned either upstream or downstream of a POE. For example, an NC is included in “Headend” equipment that is upstream of a BCN. Such an NC coordinates upstream and downstream signals from/to each link of a BCN. Typically, an NC can support only a maximum number of clients at a time because of resource limitations of the NC, such as memory and other NC hardware, and reduced overall network throughput and latency. Such limitations may render a network incapable of satisfying evolving demands on a network to include additional clients, such as a desire to place more CPE's on a BCN. Accordingly, there is a need for a method and apparatus for extending the number of CPE's that can be used in a BCN.

### BRIEF DESCRIPTION OF THE FIGURES

Non-limiting and non-exhaustive embodiments will be described with reference to the following figures, wherein like reference numerals refer to like parts throughout the various figures unless otherwise specified.

FIG. 1 is a schematic diagram illustrating a coaxial cable network, according to an embodiment of the disclosed method and apparatus.

FIG. 2 is a schematic diagram illustrating a selection of a client for removal from a network, according to an embodiment of the disclosed method and apparatus.

FIG. 3 is a flow diagram of a network controller process, according to an embodiment of the disclosed method and apparatus.

### DETAILED DESCRIPTION

In the following detailed description, numerous specific details are set forth to provide a thorough understanding of the claimed subject matter. However, it will be understood by those skilled in the art that the claimed subject matter can be practiced without these specific details. In other instances, well-known methods, procedures, components, and/or circuits have not been described in detail so as not to obscure the claimed subject matter.

In one embodiment of the disclosed method and apparatus, a coaxial cable network, such as a broadband cable network (BCN), includes a network coordinator (NC) to coordinate upstream and downstream transmission of information. This information typically will include multimedia data services transmitted to and from each link of the network. “Links” (which some refer to as “channels”) provide connections between an NC and associated clients. The term “client” is herein used interchangeably with the term “node”. Bitloading refers to the use of particular modulation techniques for transmission of information over a link to a client, such as a network client of a BCN, for example. Such techniques consider link characteristics, such as, for example, length, quality of link connections, and/or any other features of a link to a client that affects transmission of a message transmitting thereon. A modulation technique is chosen, for example, to provide a high rate of data transfer over a link while maintaining an acceptable bit error rate. Bitloading involves transmitting symbols representing bits via carriers in an orthogonal frequency division multiplexing (OFDM) signal. For example, symbols are transmitted downstream from an NC to a client over a link via 256 carriers (or some subset of the 256 carriers), each carrier assigned to a different frequency and modulated with bits according to a respective modulation, such as QAM (Quadrature Amplitude Modulation) 16, QAM 32, BPSK (Binary Phase Shift Keying), and so on. Such symbols make up packets comprising a header, or preamble, and a payload. Both the header and the payload include information that is interpreted by an NC and/or a client. For packets heading downstream, for example, a header includes information to be read by clients that describes which client is an intended recipient of a corresponding payload.

In one embodiment, an NC is capable of supporting only a maximum number of clients because of resource limitations of the NC, such as memory and other NC hardware, as mentioned above. Accordingly, there is a limit on the number of members that can participate in the network. However, there are times when it is desirable for a process to enable an NC to service more than such a maximum number of clients. Accordingly, in one embodiment of the disclosed method and apparatus, such an NC will temporarily drop an inactive client out of a network to allow another client, which is currently not in the network and wishes to be active, to join the network. In one embodiment, an NC stores information regarding one or more states of such a dropped client at the time the client is dropped from the network. It will be understood by those skilled in the art that the information can be stored in any type of memory device, either internal to the NC or outside of the NC, so long as the information is available upon request at a later time.

As illustrated below, such stored information includes communication link reestablishment information (CLRI), to be used in quickly rejoining the dropped client with the network. As discussed below, such CLRI includes, for example, bitloading last applied to carriers of a link in transmitting information to the dropped client at a time when the client is dropped from the network.

An NC may receive a request to allow a dropped client to rejoin the network. Also, as will be discussed below, the NC may send a request to a client to ask the client to join the network. Depending on how long it has been since the client was dropped, all or a portion of previously stored CLRI may be used to allow the client to rapidly rejoin. The sooner a dropped client is rejoined, the greater the portion of previously stored CLRI that may be used, since such CLRI becomes less applicable over time in the dynamic conditions that typically exist in the network. In another example, a bitload margin is added to the bitloading information included in a previously stored CLRI. Bitloading over a particular link is determined by using a probe signal to measure the quality of the link, e.g., the SNR on each carrier at the receiving end of the link. The SNR is then used to determine a modulation scheme, such as 128QAM, 64QAM, and so on, based on a desired bit error rate for communications over the link. A bitload margin may be added to modify the measured SNR for each carrier before calculating a carrier's bitloading. If the modification decreases the SNR sufficiently, then such a modification for each carrier translates into a lower bitloading (i.e., less efficient modulation scheme in terms of the amount of information that can be communicated in one symbol). Such a bitload margin is used in one embodiment of the disclosed method and apparatus to account for possible degradation of link quality resulting from physical changes, such as temperature changes, and the resulting changes in bitloading that would occur to the network due to such physical changes in the network.

In the description of the following embodiments, a client that is included in a network is referred to as a member client, and a client not in a network is referred to as a nonmember client. A process that allows the swapping of a member client with a nonmember client allows a nonmember client to join quickly (i.e., become a member client) and communicate upstream and/or downstream packets with an NC.

In one embodiment, a dropped client makes the request to rejoin a network. In another embodiment, an entity other than the client that wishes to rejoin makes the request for the nonmember client to rejoin the network. For example, in one embodiment, an NC includes a transmitter to send a request to a receiver of a nonmember client to rejoin a network. Such may be the case if the NC has data to send to a nonmember client. The NC includes a memory to store cached information related to the link between an NC and the nonmember client. In an alternative embodiment, the nonmember client includes a memory to store such cached information, which is used by a processor to rejoin the nonmember client to the network. The nonmember client stores such information from the time it was last a member of the network. In yet another embodiment, the request is made from a nonmember of the network.

In one embodiment, as mentioned above, a dropped client joins a network by any of at least three rejoin processes. Which particular rejoin process is selected is determined based upon the amount of time that has passed since the client that is rejoining was removed from the network, i.e., how long the client has been dropped. In a first relatively fast, expedited rejoin process, a former bitloading or other portion of a CLRI, for example, is reapplied to the rejoined client.

In a second rejoin process, a bitload margin is added to the former bitloading to be applied to the rejoined client. Whether to apply the second rejoin process instead of the first rejoin process, which does not add a bitloading margin, depends on how much time has passed since the rejoined client was last in the network, for example. Of course, the greater the passage of time, the more opportunity exists for physical parameters, such as temperature for example, of a network to change.

Finally, in a third rejoin process, which applies, for example, if the client was dropped a long time ago (e.g., greater than fifteen minutes), rejoining a client to a network involves a substantially complete admission process, since the CLRI associated with that client no longer accurately applies to the client and/or the network as will be explained below.

As mentioned above, if a member client is removed from a network, information regarding the member client is stored, such as in a cache memory associated with a client and/or an NC. Such stored information is used to expedite a process of rejoining the client to the network at some future time, as mentioned above. For example, an NC stores CLRI associated with the client such as a most-recent bitloading for the client, log gain, digital gain, alpha1, alpha2, beta-shift, cyclic prefix (CP) length, phase-bias, and system bias, just to name a few examples of parameters that are stored by an NC to enable the NC to efficiently receive a packet from a client. The NC also stores a preamble type, transmit power adjustment, bitloading, and CP length, just to name a few examples of parameters stored to assist the NC in transmitting a packet to a client. Meanwhile, the client stores similar information (e.g., a preamble type, transmit power adjustment, bitloading, and CP length, just to name a few examples of parameters stored by a client) to enable the client to transmit a packet to an NC and to receive a packet from an NC. Such information is stored for a limited time, such as until network parameters have changed so substantially as to render such stored information obsolete.

In one embodiment, the CLRI associated with a particular client includes Media Access Control (MAC) addresses of devices downstream of the associated client. Such a stored MAC address allows an NC to determine which client is associated with an Ethernet packet that the NC receives, for example, and to determine whether the client is a member or non-member of the network.

In one implementation, the CLRI is stored for up to five minutes. If the client requests to rejoin a network within those five minutes, then the rejoining process is relatively fast and simple, as in the first rejoin process described above. In one embodiment, one or more portions of the CLRI are retained longer than other portions. For example, in one embodiment, a bitloading portion is stored for up to ten minutes longer than the other portions of the CLRI. In one such embodiment, if such a bitloading value is stored for a relatively long time, then a bitloading margin is added to account for possible network parameter changes, as mentioned for the second process described above. Alternatively, the bitloading parameter is used without such a bitloading margin.

If a relatively long time, such as fifteen minutes, elapses before a client requests to rejoin a network, any previously stored information is disregarded, and the client is subjected to a full admission process to be rejoined. Ali admission process, for example, involves determining the bitloading of a link in both directions between an NC and a client. A process for such a determination includes transmitting and receiving bitloading probes in both link directions, sending a bitloading report request, calculating bitloading at a receiver, and sending the bitloading report back to a transmitter.

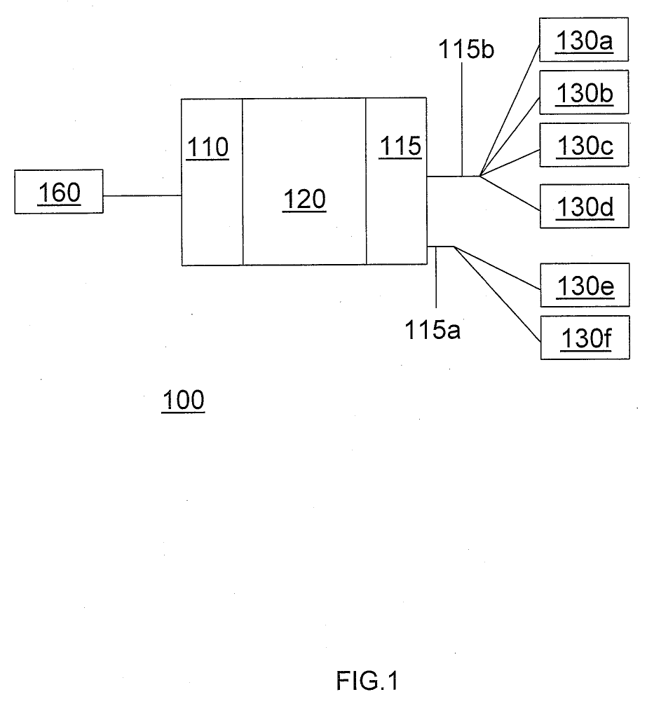

FIG. 1 is a schematic diagram that illustrates a network 100, such as a BCN, in accordance with one embodiment. The network 100 includes an Access network and/or a Mesh network. However, those skilled in the art will understand that other network architectures are possible. In one embodiment, an Access network employs an NC 120 for inter-client communication. Alternatively, a Mesh network allows one client to communicate directly with another client. The NC 120 receives information via communication port 110 from an upstream source, such as a router 160. Such information, which is in packet form, includes video packets or program guide data (e.g., as in IPTV), just to name a few examples. In one embodiment, a communication port 110 and/or an NC 120 are positioned downstream of a POE (not shown) and from the router 160. In another embodiment, the communication port 110 and/or the NC 120 are positioned upstream of such a POE. The NC 120 forwards at least a portion of the information it receives through a downstream (DS) port 115 and on to one or more connected clients 130a through 130f. In one embodiment, the NC 120 includes a receiver (not shown) to receive data packets via coax cable. The communication port 110 comprises a cable modem, for example. The communication port 110 is connected to and receives signals from one or more entities in addition to the router 160. In one embodiment, the router 160, the NC 120, and the clients 130 are part of the communication network 100.

The DS port connections 115a, 115b depict examples of connections between the DS port 115 and downstream clients 130. The DS port connections 115a, 115b include a splitter network to allow a packet to be passed downstream to more than one of the clients 130. In FIG. 1, the clients 130a, 130b, 130c, and 130d are connected to the DS port 115 via the DS port connection 115b, and the clients 130e and 130f are connected to the DS port 115 via the DS port connection 115a, although any number of clients may be connected to the DS port 115 via any number of the DS port connections and configurations. In a BCN, for example, the medium is shared. Accordingly, multiple clients are typically connected to a single physical port. However, the NC 120 may provision ports as virtual ports from the single physical port. In one embodiment, the network described above is configured according to a standard, MoCA 1.1, which was generated by an organization called “MoCA” (the “Multimedia over Coax Alliance”).

In one embodiment, the router 160 receives data traffic from an upstream video server (not shown). The data includes packets containing content, such as a multicast data stream. The router 160 comprises a multi-port switch/router and receives data traffic from one or more servers (not shown). Upon receiving such data traffic, the router 160 routes traffic onto the network 100 and through the network 100 downstream to clients within the network 100. For example, video data streams, such as data representing high-definition television (HDTV) signals, are differentiated from each other by a group number included in an address, such as a MAC address. A data stream comprises, for example, MPEG video transmitted in internet protocol (IP) multicast packets, which make up the data stream. It should be understood by those skilled in the art that in one embodiment, the router 160 is collocated with the NC 120. Alternatively, the router 160 and the NC 120 are distinct entities.

The NC 120 communicates with the connected clients 130, though the clients 130 may or may not be capable of communicating with one another. The NC 120 monitors upstream communications from each of the clients 130 in the network. Such communications, as explained below, include a client request to join a network, for example.

In one implementation, the NC 120 periodically issues a media access plan (MAP) packet over a network to member clients. Another periodic signal, a beacon packet, is also sent by the NC 120 and received by all clients connected to the port 115, including nonmember clients. MAP packets are transmitted over the network in a bitloaded mode. This is possible because the NC 120 has bitloading information for all of the clients on the network. Accordingly, such MAP packets are capable of carrying a substantial amount of information. In contrast, a beacon packet carries relatively little information. However, a beacon packet is more reliable and robust than a MAP packet. A beacon packet is intended for nonmember clients, supplying timing information for a contention slot, such as an admission control frame (ACF). In one embodiment of the disclosed method and apparatus, a client can determine from a beacon/ACF message exchange whether it can and/or should become a member of the network. For example, NC 120 may send a request for a nonmember client to join the network in a beacon packet. A MAP packet is received by a member client after the member client determines the bitloading of the MAP packet. Such MAP packets may not be received by nonmember clients.

Referring to FIG. 1, an example of a process of swapping clients in and out of a network is now described. Any one or more of the clients 130 are member or nonmember clients of the network. For the present example, say that clients 130b, 130c, 130d, and 130e comprise member clients, and that clients 130a and 130f are nonmember clients.

Client 130a, for example, requests to send traffic, such as data packets, to the NC 120. Such a request requires adding the nonmember client 130a to the network 100. The request is sent to the NC 120 within a contention slot, such as an ACF, which may periodically occur on the network. An ACF comprises a general purpose area where messages can be sent and received to and from an NC and clients. An ACF may be a contention slot by one or more nonmember clients. Accordingly, an ACF can be used to send admission requests to the NC 120 to start an admission process. Beacon packets, described above, are used for timing ACF's for nonmember clients. Each beacon points to an ACF.

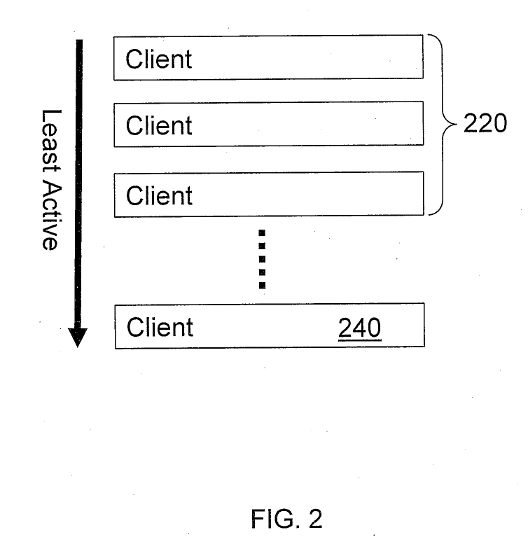

In one embodiment, the NC 120 includes a processor (not shown) to determine whether a number of clients participating as members of the network is at a limit. If the NC 120 is already managing a maximum number of clients, then, upon receiving an admission request, the NC 120 uses the processor to determine which member client to remove from the network. In one embodiment, a least-active member client 240 is chosen for removal, as depicted in FIG. 2. Such a member client may have had less recent data traffic than other member clients 220, or the longest time since it last communicated a packet with the NC 120, for example. However, such a process of determining which client to drop from a network is not limited to these examples. Alternative criteria for dropping a member client includes, for example, the quality of the link to a member client, the likelihood that information will be communicated to the member client in the near future, the relative importance of each member client, etc. It will be understood by those skilled in the art that there are many additional criteria that would be appropriate to use in determining which member client to drop.

Once the NC 120 drops a client, such as client 130c in FIG. 1, to accommodate requesting client 130a, the NC 120 sends a response back to the requesting client 130a acknowledging acceptance of the request during a beacon period. Also, the NC 120 includes, for example, a memory (not shown) to store information related to a link between the NC 120 and the dropped client. In one embodiment, a requesting client listens for an acknowledging response from the NC 120. A response includes instructions to the requesting client regarding which process to use to join the network, such as one of the three processes described above. The NC 120 formulates such instructions by utilizing, for example, a cache memory that includes CLRI stored previously as discussed above. In one embodiment, the instructions are determined, at least in part, by considering how long it has been since the displaced clients left the network. Alternatively, other means, such as the reliability of the CLRI, may be used to determine which process to use in joining the network. Those skilled in the art will understand that there are a multitude of criteria that might be used to determine which process should be selected for joining the network.

Meanwhile, the NC 120 transmits a MAP packet over the network to inform the dropped client 130c that it is no longer a member client of the network 100. At this time, the client 130c and/or the NC 120 cache information (CLRI) regarding the parameters that were used while the client 130c was connected to the network. Such information is used as CLRI if and when client 130c later requests to rejoin the network, as explained above. Also, the client 130c previously received MAP packets when it was a member of the network, but now, as a nonmember, the client 130c instead receives only beacon packets.

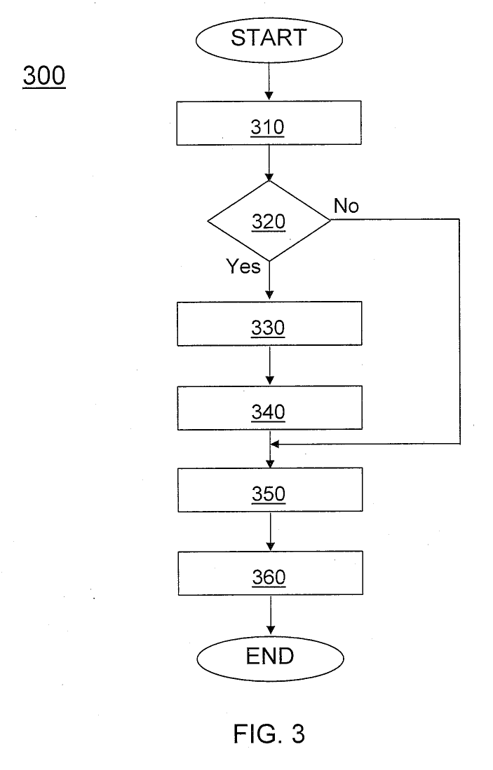

FIG. 3 is a flow diagram of a process 300 that is carried out by an NC, such as the NC 120 shown in FIG. 1, according to one embodiment of the disclosed method and apparatus. The NC 120 manages more than a limited number of member clients by swapping such member clients with nonmember clients in and out of a network, for example. At block 110, the NC 120 receives a request from a nonmember client 130a to join the network 100. Such a request is received in an ACF, as explained above. At block 320, the NC 120 determines whether a maximum number of clients are included in the NC's network. If not, then the NC 120 sends a response in a beacon slot to the requesting client 130a indicating that the requesting client 130a may join the network 100, as at block 350. However, if the NC 120 is already managing a maximum number of member clients 130 on the network 100, then the NC 120 determines which of these member clients 130 to remove from the network, as at block 330. Next, the NC 120 gathers and caches information regarding the dropped member client 130c, as at block 340. Such information includes parameters used by the NC 120 to communicate with the dropped client 130c just before it was removed from the network 100. For example, such parameters include information that is used as CLRI. Next, at block 350, the NC 120 determines how the requesting nonmember client 130a is to be rejoined onto the network 100. Such a determination considers how long the requesting nonmember client 130a had been separated from the network 100, since physical parameters of the network 100 change over time, as mentioned above. If the duration that the client 130a has been separated from the network 100 is relatively short, then the NC 120 assumes only insignificant parameter changes to the link to and from the requesting client 130a. Accordingly, the NC 120 rejoins the requesting client 130a by utilizing cached information (CLRI) from when the requesting client 130a was last on the network 100. If, however, the separated time is relatively long, the NC 120 uses only a portion of cached information (CLRI) or none of the cached information, and the requesting client must go through a full admission process. At block 360, the NC 120 sends a response to the requesting nonmember client 130a that its request has been granted and indicating the rejoin process that the joining client should use. Such a response is sent over a beacon period.

In another embodiment, a beacon packet includes a request from the NC 120 for a nonmember client 130a to join the network 100. Such may be the case if, for example, the NC 120 includes data to transmit to a nonmember client 130a.

Unless specifically stated otherwise, as apparent from the following discussion, it should appreciated by those skilled in the art that throughout this specification discussions using terms such as “processing”, “computing”, “calculating”, “associating”, “identifying”, “determining” and/or similar terms refer to the actions and/or processes of an executing device, such as a computing platform, a computer, or a similar electronic computing device, that manipulates and/or transforms data represented as physical electronic and/or magnetic quantities within the executing device's memories, registers, and/or other information storage, transmission, and/or display devices.

The particular features, structures, or characteristics disclosed herein may be combined in any suitable manner in one or more of the embodiments of the disclosed method and apparatus. The term “and/or” as used herein means one or all of the options, either taken alone, together or in any combination.

While the disclosed method and apparatus illustrate and describe what are presently considered to be examples of the features of the disclosed method and apparatus, it will be understood by those skilled in the art that various other modifications may be made, and equivalents may be substituted. Additionally, many modifications may be made to adapt to a particular situation without departing from the central concept described herein. Therefore, it is intended that claimed subject matter not be limited to the particular examples disclosed, but that such claimed subject matter may also include all aspects that fall within the scope of the appended claims, and the equivalents of those claims.

Though claims may include letters to delineate individual elements and/or process steps, such letters do not necessarily denote order or hierarchy of importance of any aspect of the claim language.

What is claimed is:

1. A method for adding members to a network beyond a limit to the number of clients that can otherwise participate as members of the network, the method comprising:
a) receiving a request from a client to join as a participant on the network;
b) determining whether the number of clients currently participating as members is at the limit;
c) selecting at least one client to be removed from the network in response to determining that said limit is exceeded; and
d) storing information associated with the connection between the client to be removed and the network.

2. The method of claim 1, wherein storing information comprises maintaining communication link reestablishment information (CLRI) regarding the at least one removed client.

3. The method of claim 2, further comprising:
e) receiving a second request from the at least one removed client, the request asking that at least one of the removed clients rejoin the network; and
f) rejoining the second requesting clients in response to receiving the second request by applying at least a portion of the CLRI.

4. The method of claim 3, wherein the portion of the CLRI is based, at least in part, upon how long it has been since the second requesting clients were members of the network.

5. The method of claim 3, wherein the portion of the CLRI is based, at least in part, upon the difference between a bitloading used by the second requesting clients at a time when the second requesting clients were removed from the network and a bitloading to be used at a time when the second request is received.

6. The method of claim 1, wherein selecting the at least one client to be removed is based, at least in part, upon the level of activity of the clients of participating in the network at the time of the request.

7. An article having a storage medium on which machine-readable instructions are stored which, if executed by an execution device, are adapted to direct the executing device to:
a) receive a request from a client to join a network;
b) determine if a number of clients participating as members on the network is at a limit;
c) select at least one client to be removed from the network in response to determining that the number of clients is at the limit; and
d) storing information related to the link to and from the client to be removed.

8. The article of claim 7, wherein the instructions, if executed, are further adapted to direct said execution device to:
e) receive a second request from the at least one removed client, the request asking that at least one of the removed clients rejoin the network; and
f) rejoin the second requesting clients in response to receiving the second request by applying at least a portion of the stored information.

9. The article of claim 8, wherein the portion of the stored information is based, at least in part, upon how long it has been since the second requesting clients were members of the network.

10. The article of claim 8, wherein the portion of the stored information is based, at least in part, upon the difference between a bitloading used by the second requesting clients at a time when the second requesting clients were removed from the network and a bitloading to be used at a time when the second request is received.

11. The article of claim 7, wherein selecting the at least one client to be removed is based, at least in part, upon the level of activity of the clients of participating in the network at the time of the request.

12. An apparatus comprising:
a) means for receiving a request from at least one client to join a network;
b) means for determining if the number of clients participating as members of the network is at a limit;
c) means for selecting at least one client to be removed from the network in response to determining that the number of clients participating as members is at the limit; and
d) storing information regarding a link to and from the at least one client to be removed.

13. The apparatus of claim 12, further comprising:
e) means for receiving a second request from the at least one removed client, the request asking that at least one of the removed clients rejoin the network; and
f) means for rejoining the second requesting clients in response to receiving the second request by applying at least a portion of the stored information.

14. The apparatus of claim 13, wherein the portion of the stored information is based, at least in part, upon how long it has been since the second requesting clients were members of the network.

15. The apparatus of claim 13, wherein the portion of the stored information is based, at least in part, upon the difference between a bitloading used by the second requesting clients at a time when the second requesting clients were removed from the network and a bitloading to be used at a time when the second request is received.

16. The apparatus of claim 12, wherein selecting the at least one client to be removed is based, at least in part, upon the level of activity of the clients of participating in the network at the time of the request.

17. A network controller comprising:
a) a receiver to receive a request from a client to join a network;
b) a processor to determine if a number of clients participating as members of the network is at a limit and to select at least one client to be removed from the network in response to determining that the number of clients is at said limit; and
c) a memory to store information related to a link between the network controller and the at least one client to be removed.

18. The network controller of claim 17, wherein said receiver is adapted to receive a second request from the at least one removed client, the request asking that at least one of the removed clients rejoin the network, and said processor is adapted to rejoin the second requesting clients in response to receiving the second request by applying at least a portion of the stored information.

19. The network controller of claim 18, wherein the portion of the stored information is based, at least in part, upon how long it has been since the second requesting clients were members of the network.

20. The network controller of claim 18, wherein the portion of the stored information is based, at least in part, upon the difference between a bitloading used by the second requesting clients at a time when the second requesting clients were removed from the network and a bitloading to be used at a time when the second request is received.

21. The network controller of claim 17, wherein selecting the at least one client to be removed is based, at least in part, upon the level of activity of the clients of participating in the network at the time of the request.

22. A network controller comprising:
a) a transmitter to send a request to a client to ask the client to rejoin a network in response to the network controller having data to send to the client;
b) a processor to determine if a number of clients participating as members of the network is at a limit and to select at least one client to be removed from the network in response to determining that the number of clients is at said limit.

23. A client comprising:
a) a memory to store cached information related to a link between a network controller and the client;
b) a receiver to receive a request from the network controller to ask the client to rejoin the network; and
c) a processor to use the cached information to rejoin the client to the network.

24. The client of claim 23, wherein said cached information comprises communication link reestablishment information (CLRI) regarding the client.

25. The client of claim 23, wherein said request from the network controller is received in response to the network controller having data to send to the client.

26. A method for rejoining a client to a network beyond a limit to the number of clients that can otherwise participate as members of the network, the method comprising:
a) storing cached information related to a link between a network controller and the client;
b) receiving a request from the network controller to ask the client to rejoin the network; and
c) using the cached information to rejoin the client to the network.

27. The method of claim 26, wherein said cached information comprises communication link reestablishment information (CLRI) regarding the client.

28. The method of claim 26, wherein said request from the network controller is received in response to the network controller having data to send to the client.

29. An apparatus comprising:
a) means for storing cached information related to a link between a network controller and the client;
b) means for receiving a request from the network controller to ask the client to rejoin the network; and
c) means for using the cached information to rejoin the client to the network.

30. The apparatus of claim 29, wherein said request from the network controller is received in response to the network controller having data to send to the client.

31. An article comprising a storage medium comprising machine-readable instructions stored thereon which, if executed by an execution device, are adapted to direct said execution device to:
a) store cached information related to a link between a network controller and a client;
b) receive a request from the network controller to ask the client to rejoin the network; and
c) use the cached information to rejoin the client to the network.

32. The article of claim 31, wherein said request from the network controller is received in response to the network controller having data to send to the client.
